(19) United States
(12) Patent Application Publication
(10) Pub. No.: US 2022/0408307 A1
(43) Pub. Date: Dec. 22, 2022

(54) ROADSIDE APPARATUS AND COMMUNICATION CONGESTION CONTROL METHOD

(71) Applicant: PANASONIC INTELLECTUAL PROPERTY MANAGEMENT CO., LTD., Osaka (JP)

(72) Inventors: Tsuyoshi UENO, Kanagawa (JP); Hiroaki SUDO, Kanagawa (JP); Koichi AIHARA, Kanagawa (JP); Makoto YASUGI, Tokyo (JP); Yoichi NAKAGAWA, Tokyo (JP)

(21) Appl. No.: 17/619,492

(22) PCT Filed: Jun. 3, 2020
(86) PCT No.: PCT/JP2020/021943

§ 371 Date: Dec. 15, 2021

(30) Foreign Application Priority Data
Jun. 26, 2019 (JP) 2019-118851

(51) Int. Cl. H04W 28/02; H04W 64/00

(52) U.S. Cl. CPC H04W 28/0289; H04W 64/006

(57) ABSTRACT

The present invention relates to a communication system which can effectively avoid congestion in ITS communications at a street intersection to properly assist the driving of autonomous vehicles. An information source roadside apparatus 3 acquires terminal movement information on movement directions of nearby pedestrian terminals, and transmits the information to an information destination roadside apparatus, which determines, based on the received information, if there is predicted congestion in the terminal-to-terminal communications at a predetermined future time. When determining that there is predicted congestion, the information destination roadside apparatus transmits an instruction for a congestion avoidance operation to the pedestrian terminals 1. Then, each pedestrian terminal performs the congestion avoidance operation by switching a communication mode from a direct communication mode using the terminal-to-terminal communications, to an indirect communication mode using communications via a roadside apparatus.

### TECHNICAL FIELD

The present disclosure relates to a roadside apparatus installed on a road for communicating with terminal devices carried by pedestrians and/or vehicles on the road, and a communication congestion control method for avoiding congestion in terminal-to-terminal communications performed between terminal devices.

### BACKGROUND ART

In recent years, safe driving assistance wireless systems utilizing ITS (Intelligent Transport System) have been practically used. Furthermore, studies have been in progress for the practical use of self-driving systems for assisting the driving of autonomous vehicles, in particular, by utilizing ITS communications in such systems. However. utilizing ITS communications in such self-driving systems can result in a problem that the occurrence of congestion in the ITS communications prevents the system from properly assisting the driving of autonomous vehicles.

Known technologies for assisting the driving of vehicles include a system for cooperatively operating multiple roadside apparatuses installed at the corresponding intersections to enable information to be transferred from one roadside apparatus to another, whereby vehicles within a wide area can be notified of the approach and the movement direction of an emergency vehicle (See Patent Document 1).

Moreover, known technologies for avoiding congestion in communications in a communication area of a roadside apparatus include a system for controlling communications so as to avoid communication congestion by predicting the number of vehicles to enter the communication area; that is, the number of in-vehicle terminals mounted in those vehicles (See Patent Document 2).

Patent Document 1: JP2015-106294A

Patent Document 2: JP2001-093086A

### SUMMARY OF THE INVENTION

### Task to be Accomplished by the Invention

However, the system disclosed in Patent Document 1 is capable of only notifying vehicles of the approach of an emergency vehicle, and cannot avoid communication congestion which occurs near a self-driving vehicle. The system disclosed in Patent Document 2 involves enormous cost of installing axial-load sensors at a numerous number of street intersections and thus cannot be a practical solution of the problem of communication congestion at street intersections.

The present invention has been made in view of the problems of the prior art, and a primary object of the present invention is to provide a roadside apparatus and a communication congestion control method for effectively avoiding congestion in ITS communications at a street intersection to thereby properly assist the driving of autonomous vehicles.

### Means to Accomplish the Task

An aspect of the present invention provides a roadside apparatus comprising: a first communication device configured to communicate with terminal devices carried by mobile bodies on a road by a communication method common to that used in the terminal-to-terminal communications; a second communication device configured to communicate with a second roadside apparatus; and a processor configured to perform controls so as to avoid congestion n the terminal-to-terminal communications, wherein, when the second communication device receives terminal status information from the second roadside apparatus, the terminal status information indicating a status of a terminal device located near the second roadside apparatus, the processor determines whether or not there is predicted congestion in the terminal-to-terminal communications at a predetermined future time based on the terminal status information, and when determining that there is predicted congestion in the terminal-to-terminal communications at the predetermine future time, the processor transmits an instruction for a congestion avoidance operation to restrict the terminal-to-terminal communications from the first communication device to the terminal devices.

Another aspect of the present invention provides a communication congestion control method for avoiding congestion in terminal-to-terminal communications performed by terminal devices carried by mobile bodies on a road, the method comprising: an information source roadside apparatus acquiring terminal status information indicating a status of a terminal device located near the information source roadside apparatus; the information source roadside apparatus transmitting the acquired terminal status information to an information destination roadside apparatus; upon receiving the terminal status information from the information source roadside apparatus, the information destination roadside apparatus determining whether or not there is predicted congestion in the terminal-to-terminal communications at a predetermined future time based on the terminal status information; when determining that there is predicted congestion in the terminal-to-terminal communications at the predetermine future time, the information destination roadside apparatus transmitting an instruction for a congestion avoidance operation to restrict the terminal-to-terminal communications, to the terminal devices; and upon receiving the instruction for the congestion avoidance operation from the information destination roadside apparatus, the terminals performing the congestion avoidance operation.

### Effect of the Invention

According to the present disclosure, adjacent roadside apparatuses cooperatively operate to exchange terminal status information with each other, the terminal status information indicating a status of each terminal device located in the respective roadside apparatuses' communication areas, to thereby predict congestion in terminal-to-terminal communications (vehicle-to-vehicle communications and pedestrian-to-vehicle communications) in nearby areas (such as areas around street intersections at which the apparatuses are installed), which enables accurate prediction of congestion in the terminal-to-terminal communications. When there is predicted congestion in the terminal-to-terminal communications at a predetermined future time, an instruction for a congestion avoidance operation o restrict the terminal-to-terminal communications is transmitted to terminal devices, which can proactively establish a condition in which congestion in the terminal-to-terminal communications is unlikely to occur. As a result, it becomes possible to effectively avoid congestion in the terminal-to-terminal communications and improve the stability of the terminal-to-terminal communications, to thereby properly assist the driving of autonomous vehicles.

### BRIEF DESCRIPTION OF THE DRAWINGS

FIG. 1 is a diagram showing a general configuration of a communication system according to a first embodiment of the present invention;

FIG. 2 is an explanatory diagram showing an outline of communication congestion control performed by roadside apparatuses 3 according to the first embodiment;

FIG. 3 is an explanatory diagram showing direct communications and indirect communications performed by a pedestrian terminal 1 according to the first embodiment;

FIG. 4 is a block diagram showing a schematic configuration of a pedestrian terminal 1 according to a first embodiment;

FIG. 5 is a block diagram showing a schematic configuration of an in-vehicle terminal 2 according to the first embodiment;

FIG. 6 is a block diagram showing a schematic configuration of a roadside apparatus 3 according to the first embodiment;

FIG. 7 is a flow chart showing an operation procedure of operations for terminal status notification performed by an information source roadside apparatus 3 according to the first embodiment;

FIG. 8 is a flow chart showing an operation procedure of operations performed by an information destination roadside apparatus 3 according to the first embodiment when there is predicted communication congestion;

FIG. 9 is a flow chart showing an operation procedure of a congestion avoidance operation performed by a pedestrian terminal 1 according to the first embodiment;

FIG. 10 is an explanatory diagram showing an outline of a communication system according to a first variation of the first embodiment of the present invention;

FIG. 11 is an explanatory diagram showing an outline of a communication system according to a second variation of the first embodiment of the present invention;

FIG. 12 is an explanatory diagram showing an outline of a communication system according to a third variation of the first embodiment of the present invention;

FIG. 13 is an explanatory diagram showing an outline of a communication system according to a fourth variation of the first embodiment of the present invention;

FIG. 14 is a diagram shoving a general configuration of a communication system according to a second embodiment of the present invention;

FIG. 15 is a block diagram showing a schematic configuration of an in-vehicle terminal 2 according to the second embodiment;

FIG. 16 is a block diagram showing a schematic configuration of a roadside apparatus 3 according to the second embodiment;

FIG. 17 is a flow chart showing an operation procedure of operations performed by a roadside apparatus 3 according to the second embodiment when there is predicted communication congestion;

FIG. 18 is a flow chart showing an operation procedure of a congestion prediction transfer operation performed by the roadside apparatus 3 according to the second embodiment; and

FIG. 19 is a flow chart showing an operation procedure of a communication mode selection operation performed by an in-vehicle terminal 2 according to the second embodiment.

### DESCRIPTION OF THE PREFERRED EMBODIMENT(S)

A first aspect of the present invention made to achieve the above-described object is a roadside apparatus comprising: a first communication device configured to communicate with terminal devices carried by mobile bodies on a road by a communication method common to that used in the terminal-to-terminal communications; a second communication device configured to communicate with a second roadside apparatus; and a processor configured to perform controls so as to avoid congestion in the terminal-to-terminal communications, wherein, when the second communication device receives terminal status information from the second roadside apparatus, the terminal status information indicating a status of a terminal device located near the second roadside apparatus, the processor determines whether or not there is predicted congestion in the terminal-to-terminal communications at a predetermined future time based on the terminal status information, and when determining that there is predicted congestion in the terminal-to-terminal communications at the predetermine future time, the processor transmits an instruction for a congestion avoidance operation to restrict the terminal-to-terminal communications from the first communication device to the terminal devices.

In this configuration, adjacent roadside apparatuses cooperatively operate to exchange terminal status information with each other, the terminal status information indicating, a status of each terminal device located in the respective roadside apparatuses' communication areas, to thereby predict congestion in terminal-to-terminal communications (vehicle-to-vehicle communications and pedestrian-to-vehicle communications) in nearby areas (such as areas around street intersections at which the apparatuses are installed), which enables accurate prediction of congestion in the terminal-to-terminal communications. When there is predicted congestion in the terminal-to-terminal communications at a predetermined future time, an instruction for a congestion avoidance operation to restrict the terminal-to-terminal communications is transmitted to terminal devices, which can proactively establish a condition in which congestion in the terminal-to-terminal communications is unlikely to occur. As a result, it becomes possible to effectively avoid congestion in the terminal-to-terminal communications and improve the stability of the terminal-to-terminal communications, to thereby properly assist the driving of autonomous vehicles.

A second aspect of the present invention is the roadside apparatus of the first aspect, wherein the processor is configured to: receive terminal movement information on a movement direction of the terminal device located near the second roadside apparatus as the terminal status information; acquire a predicted terminal number, the predicted terminal number being the number of one or more terminal devices present in a communication area of the first communication device at a predetermined future time, based on the terminal movement information; and when the predicted terminal number is equal to or greater than a predetermined threshold value, determine that there is predicted congestion in the terminal-to-terminal communications.

This configuration enables more accurate prediction of congestion in the terminal-to-terminal communications.

A third aspect of the present invention is the roadside apparatus of the second aspect, wherein the processor is configured to: acquire moving directions of the terminal devices located in the communication area; based on the moving directions of the terminal devices, acquire an entering terminal device number, the entering terminal device number being the number of one or more terminal devices which are predicted to enter a communication area of the second roadside apparatus located adjacent to the roadside apparatus by the predetermined future time; and transmit the entering terminal device number as terminal movement information to the second roadside apparatus located adjacent to the roadside apparatus.

This configuration enables more accurate prediction of congestion in the terminal-to-terminal communications.

A fourth aspect of the present invention is the roadside apparatus of the second aspect, wherein the processor is configured to: acquire an entering terminal device number as the terminal status information from the second roadside apparatus located adjacent to the roadside apparatus, the entering terminal device number being the number of one or more terminal devices which are predicted to enter the communication area by the predetermined future time; and add the acquired entering terminal device number to a current terminal number, the current terminal number being the number of one or more terminal devices which are currently present in the communication area, to thereby provide the predicted terminal number.

This configuration enables more accurate prediction of congestion in the terminal-to-terminal communications.

A fifth aspect of the present invention is the roadside apparatus of the second aspect, wherein the processor is configured to: acquire moving directions of the terminal devices located in the communication area; based on the moving directions of the terminal devices, acquire a leaving terminal number, the leaving terminal number being the number of one or more terminal devices which are predicted to leave the communication area by the predetermined future time; and subtract the acquired leaving terminal number from a current terminal number, the current terminal number being the number of one or more terminal devices which are currently present in the communication area, to thereby provide the predicted terminal number.

This configuration enables more accurate prediction of congestion in the terminal-to-terminal communications.

A sixth aspect of the present invention is a communication congestion control method for avoiding congestion in terminal-to-terminal communications performed by terminal devices carried by mobile bodies on a road, the method comprising: an information source roadside apparatus acquiring terminal status information indicating a status of a terminal device located near the information source roadside apparatus; the information source roadside apparatus transmitting the acquired terminal status information to an information destination roadside apparatus; upon receiving the terminal status information from the information source roadside apparatus, the information destination roadside apparatus determining whether or not there is predicted congestion in the terminal-to-terminal communications at a predetermined future time based on the terminal status information; when determining that there is predicted congestion in the terminal-to-terminal communications at the predetermine future time, the information destination roadside apparatus transmitting an instruction for a congestion avoidance operation to restrict the terminal-to-terminal communications, to the terminal devices; and upon receiving the instruction for the congestion avoidance operation from the information destination roadside apparatus, the terminals performing the congestion avoidance operation.

In this configuration, it is possible to effectively avoid congestion in the terminal-to-terminal communications and improve the stability of the terminal-to-terminal communications, to thereby properly assist the driving of autonomous vehicles, in the same manner as the first aspect.

A seventh fifth aspect of the present invention is the communication congestion control method of the sixth aspect, wherein the terminal device performs the congestion avoidance operation by switching a communication mode from a direct communication mode using the terminal-to-terminal communications, to an indirect communication mode using communications via a roadside apparatus or a base station for cellular communications.

In this configuration, a decrease in the number of terminal devices performing terminal-to-terminal communications results in a reduction in the communication traffic in a network for the terminal-to-terminal communications, which minimizes congestion in the terminal-to-terminal communications.

An eighth aspect of the present invention is the communication congestion control method of the sixth aspect, wherein the terminal device performs the congestion avoidance operation by making intervals at which the terminal device transmits messages via the terminal-to-terminal communications, longer than a standard message transmission interval.

In this configuration, a decrease in the message transmission frequency results in a reduction in the communication traffic in a network for the terminal-to-terminal communications, which minimizes congestion in the terminal-to-terminal communications.

A ninth aspect of the present invention is the communication congestion control method of the sixth aspect, wherein the terminal device determines whether or not to perform the congestion avoidance operation based on a status and an attribute of the mobile body carrying the terminal device.

In this configuration, when (i) a pedestrian as a mobile body is in a certain state (e.g., when a pedestrian is present in a dangerous area such as a roadway), (ii) a pedestrian as a mobile body has a certain attribute (e.g., when a pedestrian is a child or an elderly person who is likely to take a risky action), (iii) a vehicle as a mobile body is in a certain state (e.g., when a vehicle is moving in a dangerous way such as moving in a zigzag manner), or (iv) a vehicle as a mobile body has a certain attribute (e.g., when a vehicle is an emergency vehicle such as an ambulance), it is possible to quickly and surely notify nearby pedestrians or drivers that there is such a mobile body (pedestrian or vehicle), while avoiding congestion in the terminal-to-terminal communications.

A tenth aspect of the present invention is a communication congestion control method for avoiding congestion in terminal-to-terminal communications performed by terminal devices carried by mobile bodies on a road, the method comprising: an information source roadside apparatus determining whether or not there is predicted congestion in the terminal-to-terminal communications at a predetermined future time, when determining that there is predicted congestion in the terminal-to-terminal communications at the predetermine future time, the information source roadside apparatus transmitting congestion prediction information to an information destination roadside apparatus; upon receiving the congestion prediction information from the information source roadside apparatus, the information destination roadside apparatus transmitting the congestion prediction information to one or more terminal devices located near the information destination roadside apparatus; when receiving the congestion prediction information from the information destination roadside apparatus, a terminal device mounted in a vehicle as a mobile body performing a congestion avoidance operation by switching a communication mode from a direct communication mode using the terminal-to-terminal communications, to an indirect communication mode using communications via a roadside apparatus or a base station for cellular communications.

In this configuration, multiple roadside apparatuses cooperatively operate to transmit congestion prediction information, the congestion prediction information indicating that there is predicted congestion in the terminal-to-terminal communications, to a terminal device mounted in a vehicle located away from an area where the communication congestion is predicted to occur, so that the terminal device can switch the communication mode from the indirect communication mode to the direct communication mode by the time when the vehicle passes by a predicted congestion occurring point. As a result, the terminal device is allowed to stably exchange messages with other terminal devices through indirect communications, regardless of the occurrence of congestion in the terminal-to-terminal communications.

Embodiments of the present invention will be described below with reference to the drawings.

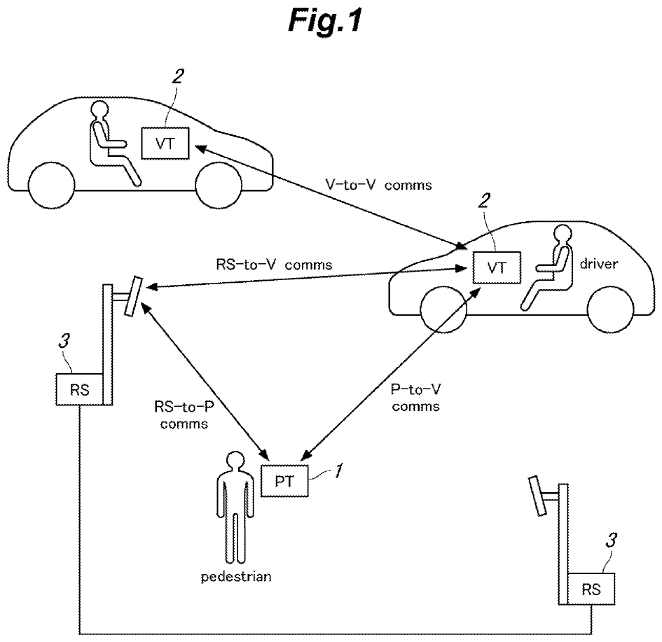

FIG. 1 is a diagram showing a general configuration of a communication system according to a first embodiment of the present invention.

The communication system includes one or more pedestrian terminals 1 (pedestrian devices, terminal devices), one or more in-vehicle terminals 2 (in-vehicle devices, terminal devices), and roadside apparatuses 3.

The pedestrian terminals 1, the in-vehicle terminals 2, and the roadside apparatuses 3 perform ITS communications (terminal-to-terminal communications) with each other. ITS communications are performed using frequency bands adopted by ITS-based (i.e., using Intelligent Transport System) safe driving assistance wireless systems (for example, 700 MHz band, 5.8 GHz band, or 5.8 GHz band). Messages including necessary information such as position data of pedestrians or vehicles are transmitted and received between such terminals and roadside apparatuses through ITS communications.

As used herein, “pedestrian-to-vehicle communications” refer to ITS communications performed between a pedestrian terminal(s) 1 and an in-vehicle terminal(s) 2, “vehicle-to-vehicle communications” refer to those performed between multiple in-vehicle terminals 2, “roadside-to-pedestrian communications” refer to those performed between a roadside apparatus(es) 3 and a pedestrian terminal(s) 1, and “roadside-to-vehicle communications” refer to those performed between a roadside apparatus(es) 3 and an in-vehicle terminal(s) 2.

A pedestrian terminal(s) 1 and an in-vehicle terminals) 2 perform Wireless LAN communications using a wireless communication system such as a WiFi (registered trademark) communication system a via a roadside apparatus 3. In the wireless LAN communications, a roadside apparatus 3 serves as a master device (access point), a pedestrian terminal(s) 1 and an in-vehicle terminal(s) 2 serve as slave device such that the roadside apparatus 3 transfers messages between the pedestrian terminal(s) 1 and the in-vehicle terminal(s) 2. The format and contents of such messages are common in ITS communications (pedestrian-to-vehicle communications) and wireless LAN communications.

Roadside apparatuses 3 are installed at respective intersections of roads, and an adjacent pair of roadside apparatuses 3 perform communications through a dedicated roadside network (wired or wireless) or any other network such as one using a cellular communication network. When the distance between an adjacent pair of roadside apparatuses 3 is relatively short, the pair of roadside apparatuses 3 may communicate with each other through ITS communications.

A pedestrian terminal 1 is carried by a pedestrian (mobile body). The pedestrian terminal 1 transmits and receives a message including position data to and from an in-vehicle terminal(s) 2 through ITS communications (pedestrian-to-vehicle communications), determines if there is a risk of collision between a pedestrian and a vehicle. When determining that there is a risk of collision, the pedestrian terminal 1 performs an alert operation for the pedestrian. The pedestrian terminal 1 may perform the alert operation by using a mobile information terminal such as a smartphone connected thereto.

An in-vehicle terminal 2 is mounted on a vehicle (mobile body). The in-vehicle terminal transmits and receives a message including position data to and from a pedestrian terminal(s) 1 through ITS communications (pedestrian-to-vehicle communications), and determines ta risk of collision between a pedestrian and a vehicle. When determining that there is a risk of collision, the in-vehicle terminal 2 performs an alert operation for the driver. The alert operation may be performed using a car navigation device connected to the in-vehicle terminal 2.

A roadside apparatus 3 is installed at a suitable place near an intersection such as a traffic light. The roadside apparatus 3 notifies a pedestrian terminal(s) 1 and an in-vehicle terminal(s) 2 that there arc pedestrians and vehicles located around the intersection, which can prevent a collision when a pedestrian and/or driver turns left or right at an intersection outside the line of sight In addition, the roadside apparatus 3 can derivers traffic information to pedestrian terminals 1 and in-vehicle terminals 2.

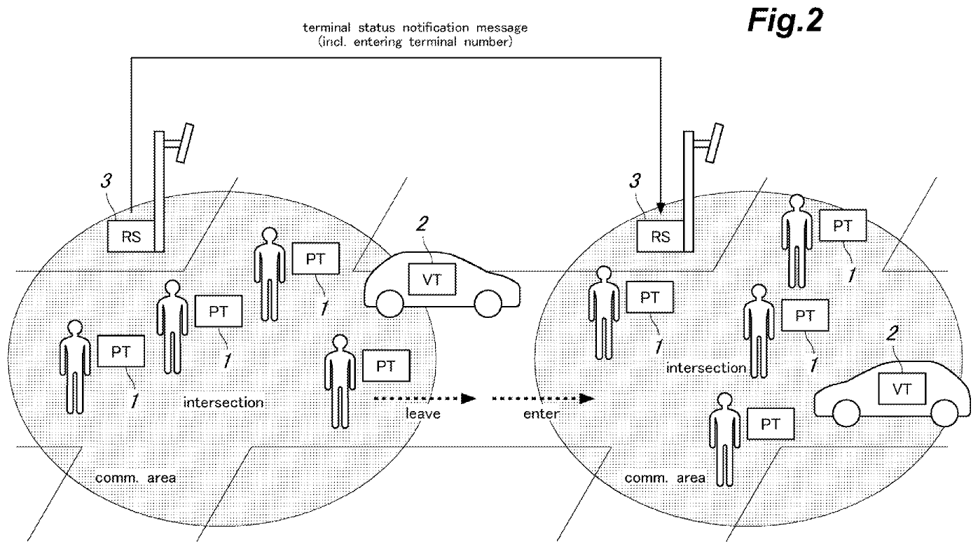

Next, communication congestion control performed by roadside apparatuses 3 according to the first embodiment will be described. FIG. 2 is an explanatory diagram showing an outline of communication congestion control performed by roadside apparatuses 3.

In the present embodiment, a plurality of roadside apparatuses 3 cooperatively collect necessary information and predict communication congestion. In the following description, a roadside apparatus 3 that transmits information to another roadside apparatus is referred to as “information source roadside apparatus”, and a roadside apparatus 3 that receives information and predicts communication congestion is referred to as “information destination roadside apparatus.” However, information is transferred between these roadside apparatuses, and each roadside apparatus 3 can serve as both an information source roadside apparatus and an information destination roadside apparatus.

A roadside apparatus 3 is installed at an intersection, and thus has its communication area around the intersection.

In an area around an intersection, an increase in the total number of pedestrians and vehicles (i.e., the total number of pedestrian terminals 1 and in-vehicle terminals 2) results in an increase in the traffic in a network for ITS communications, which can lead to the occurrence of communication congestion in the ITS communications. For example, in the case of ITS communications using the 700 MHz band, when there are more than 300 pedestrian terminals 1 and in-vehicle terminals 2 located in the communication area, the occurrence of communication congestion is significantly increased. When such communication congestion occurs, the inability to properly transfer information prevents proper self-driving control, leading to difficulty with driving of autonomous driving vehicles.

Thus, in the present embodiment, with an increase in the number of pedestrian terminals 1 located in the communication area of a roadside apparatus 3, the roadside apparatus 3 performs communication congestion control so as to restrict ITS communications performed by the pedestrian terminals 1; that is, reduce the number of the pedestrian terminals 1 that are allowed to perform ITS communications, thereby avoiding congestion in the ITS communications.

In some cases, roadside apparatuses 3 are installed at shorter intervals, and the communication areas of the roadside apparatuses 3 overlap. In such cases, a reduced number of roadside apparatuses 3 are allowed to perform communication congestion control. In some cases, a plurality of roadside apparatuses 3 are installed at an intersection. For example, a pair of roadside apparatuses 3 may be installed diagonally at an intersection. In such cases, one of the roadside apparatuses 3 mas, be allowed to perform communication congestion control at the intersection.

Moreover, at an intersection on a school road, the number of pedestrian terminals 1 in the area around the intersection can rapidly increase around the times when children go to school and leave school. In other cases, at an intersection on the road to an event venue, the number of pedestrian terminals I in the area around the intersection can rapidly increase at the start time and end time of the event. Such situations where the number of pedestrian terminals 1 increases rapidly, can cause a problem that, even when congestion in the ITS communications becomes significant, the communication congestion control by restricting ITS communications performed by the pedestrian terminals, cannot catch up with the rapid increase in the number of terminals, resulting in a sharp drop in the stability of vehicle-to-vehicle communications and difficulty with driving of autonomous driving vehicles.

Thus, in the present embodiment, the roadside apparatus 3 determines whether or not there is predicted congestion in the ITS communications at a predetermined future time, and when determining that there is predicted congestion in the ITS communications at the predetermine future time, the roadside apparatus 3 provides an instruction for a congestion avoidance operation to restrict the ITS communications to the pedestrian terminals 1, thereby proactively establishing a condition in which congestion in the ITS communications is unlikely to occur. The future time for prediction of congestion may be, for example, a predetermine time from the present. In other cases, the roadside apparatus 3 may predict congestion statuses at a plurality of future times in a stepwise manner.

In the present embodiment, the roadside apparatus 3 acquires a predicted number of pedestrian terminals 1 located in the communication area of ITS communications at a predetermined future time, and when the predicted number of PTD terminals is equal to or greater than a predetermined threshold value, the roadside apparatus 3 determines that there is predicted congestion in the ITS communications.

The threshold value used for the determination of predicted communication congestion is the number of pedestrian terminals 1 when the occurrence of congestion in the ITS communications exceeds an acceptable range, such as when the packet delivery ratio for the ITS communications becomes less than a reference level (e.g. 95%).

In the present embodiment, since the roadside apparatus 3 can receive messages transmitted from the pedestrian terminals 1 located in its communication area, the roadside apparatus 3 counts the terminal IDs included in the messages received from the pedestrian terminals 1, to thereby acquire a current terminal number, that is, the total number of pedestrian terminals 1 currently located in the communication area of the roadside apparatus 3.

The roadside apparatus 3 acquires pedestrian movement information (i.e., information about on which road, in which direction, and at what speed, each pedestrian is moving) based on pedestrian information (position, direction, speed, and other data of each pedestrian) included in messages received from the pedestrian terminals 1 and map information. Then, based on the pedestrian movement information, the roadside apparatus 3 acquires destination information for each pedestrian, the destination information including (i) information on an intersection area, i.e., a communication area. of a roadside apparatus 3 installed at an intersection at which the pedestrian is expected to arrive at a predetermined future time and (ii) information on the roadside apparatus 3 of the intersection.

Next, the roadside apparatus 3 (information source roadside apparatus) tallies destination information for the respective pedestrians, and acquires an entering terminal number (terminal movement information) for each of the roadside apparatuses at the adjacent destination intersections; that is, the number of pedestrian terminals 1 which are predicted to move from the communication area of the information source roadside apparatus 3 to enter a communication area of each adjacent roadside apparatus 3. For example, when the information source roadside apparatus 3 is provided at a crossroads intersection, where each pedestrian can move in any of the four movement directions, the information source roadside apparatus 3 acquires an entering terminal number for each of the four adjacent roadside apparatuses 3. Then, the information source roadside apparatus 3 transmits the entering terminal numbers to the corresponding adjacent roadside apparatuses 3 (information destination roadside apparatuses) via roadside-to-roadside communications.

Next, the roadside apparatus 3 acquires a leaving terminal number; that is, the total number of pedestrian terminals 1 which are predicted to leave the communication area of the roadside apparatus 3 by a predetermined future time. The leaving terminal number is the total of the numbers of pedestrian terminals I leaving the communication area in the respective directions; that is, the total of the entering terminal numbers of all the adjacent roadside apparatuses 3 (at the respective intersections).

Next, in the present embodiment, the roadside apparatus 3 acquires a predicted terminal number, the predicted terminal number being the predicted number of terminals located in the communication area at the predetermined future time, based on the current terminal number, the entering terminal number, and the leaving terminal number. Specifically, the roadside apparatus 3 calculates the predicted terminal number by adding the entering terminal number to the current terminal number and then subtracting the leaving terminal number from the resulting number as in the following equation.

Predicted terminal number=Current terminal number+Entering terminal number−Leaving terminal number.

In the present embodiment, the roadside apparatus 3 predicts the number of pedestrian terminals 1 located in the area around the intersection i.e., the communication area of the roadside apparatus 3) at a predetermined future time based on the movement statuses of pedestrian terminals 1, to predict congestion in the ITS communications. However, the roadside apparatus 3 may predict the number of pedestrian terminals 1 based on, in addition to the movement statuses of pedestrian terminals 1, historical data of the numbers of pedestrian terminals 1; that is, information records of changes in the number of pedestrian terminals 1 in the past.

The roadside apparatus 3 may perform the above-mentioned communication congestion control only at a specific time(s) of day. For example, when the roadside apparatus 3 may perform the communication congestion control only during commuting rush hours such as returning rush hours or around the times when children go to school and leave school, to thereby reduce power consumption. In other cases, when a large-scale event is held, the roadside apparatus 3 may perform the communication congestion control only when a large number of people enter or exit the event venue through a specific place.

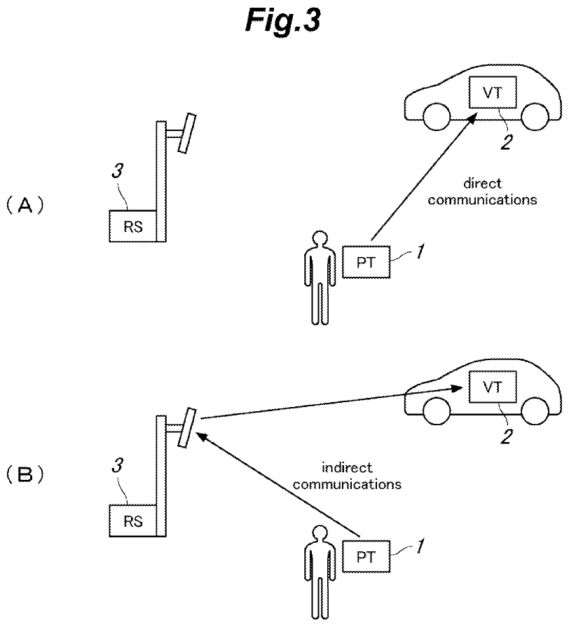

Next, direct communications and indirect communications performed by a pedestrian terminal 1 according to the first embodiment will be described. FIG. 3 is an explanatory diagram showing direct communications and indirect communications performed by a pedestrian terminal 1.

A pedestrian terminal 1 can select the communication mode between direct communication mode, in which the pedestrian terminal 1 transmits and receives messages to and from an in-vehicle terminal 2 through ITS communications (pedestrian-to-vehicle communications) as shown in FIG. 3(A), or indirect communication mode, in which the pedestrian terminal 1 transmits and receives messages to and from an in-vehicle terminal 2 via a roadside apparatus(es) 3 by using a wireless communication system such as a WiFi (registered trademark) communication system.

In the present embodiment, when determining that there is predicted congestion in the ITS communications, the roadside apparatus 3 transmits an ITS communication message including an instruction for a congestion avoidance operation to a pedestrian terminal 1, and upon receiving the message, the pedestrian terminal 1 performs the congestion avoidance operation by switching the communication mode from the direct communication mode to the indirect communication mode.

In this case, as the roadside apparatus 3 broadcasts the ITS communication message including the instruction for congestion avoidance operation, all the pedestrian terminals 1 in the communication area of the roadside apparatus 3 can perform the congestion avoidance operation in response to receiving the message. However, as a matter of course, it is not necessary for all the pedestrian terminals 1 in the communication area of the roadside apparatus 3 to perform the congestion avoidance operation.

Thus, in the present embodiment, upon receiving an ITS communication message including the instruction for congestion avoidance operation from the roadside apparatus 3, the pedestrian terminal 1 determines, based on an attribute of a pedestrian who carries it, whether or not to perform the congestion avoidance operation; that is, to switch the communication mode form the direct communication mode to the indirect communication mode. When determining that the congestion avoidance operation should be performed, the pedestrian terminal 1 performs the congestion avoidance operation. As a result, only some of the pedestrian terminals 1 in the communication area of the roadside apparatus 3 are allowed to perform the indirect communications.

Specifically, when a pedestrian who carries the pedestrian terminal 1 is in a specific state, i.e., a dangerous state (e.g., when the pedestrian is located in a dangerous area such as a roadway or when the pedestrian is a child or an elderly person who is likely to take a risky action), the pedestrian terminal 1 is prevented from performing the congestion avoidance operation. In some cases, when a pedestrian terminal 1 is carried by a pet such as a dog or a cat, the pedestrian terminal 1 may be prevented from performing the congestion avoidance operation. In other cases, with a special request from a pedestrian's family member or any other person, the pedestrian terminal 1 may be prevented from performing the congestion avoidance operation even though the pedestrian is not likely to take a risky action. For example, when there is a risk that the pedestrian cannot cross a pedestrian before the traffic light changes due to a pre-existing condition or for other reasons, the pedestrian terminal 1 is prevented from performing the congestion avoidance operation, which ensures that the pedestrian terminal 1 can quickly notify vehicles of that situation. In this way, when there is a high risk related to the pedestrian who carries the pedestrian terminal 1, the presence of the pedestrian can be surely and quickly notified to nearby pedestrians and vehicles.

In addition, for some mobile bodies such as bicycles, mobility scooters, motor-powered wheelchairs which generally move faster than pedestrians, nearby pedestrians and vehicle drivers need to be quickly and surely notified of the presence of such mobile bodies. Thus, the pedestrian terminal 1 carried in any of such mobile bodies may be prevented from performing the congestion avoidance operation, and allowed to perform direct communications on a priority basis. In other cases, mobile bodies such as vehicles, mobility scooters, and motor-powered wheelchairs may be prevented from performing the congestion avoidance operation only when the mobile bodies are driven by elderly persons.

The in-vehicle terminal 2 may be configured to perform the congestion avoidance operation in a similar manner to the pedestrian terminal 1, and determine, based on an attribute of a vehicle which carries it, whether or not to perform the congestion avoidance operation. Specifically, when the vehicle is in a certain state (e.g., when the vehicle is moving in a dangerous way such as moving in a zigzag manner), or when the vehicle has a certain attribute (e.g., when the vehicle is an emergency vehicle such as an ambulance), the in-vehicle terminal 2 is prevented from performing the congestion avoidance operation. In other words, the in-vehicle terminal 2 performs the congestion avoidance operation only when the vehicle is in a certain state or when the vehicle has a certain attribute. In some embodiments, when there is a special need, the in-vehicle terminal 2 is prevented from performing the congestion avoidance operation even though the vehicle is not moving in a dangerous way. For example, when the vehicle is a vehicle of a driving school, a vehicle with a beginner driver's mark, a vehicle driven by an elderly person, a vehicle driven by a driver who is not good at driving, the in-vehicle terminal 2 is prevented from performing the congestion avoidance operation, which ensures that the drivers are quickly notified of pedestrian information, thereby preventing traffic accidents.

The roadside apparatus 3 can broadcast an ITS communication message including an instruction for congestion avoidance operation to all the pedestrian terminals 1 in the communication area. However, in other embodiments, the roadside apparatus 3 can add the ID of a specific pedestrian terminal(s) to a message so as to transmit an instruction for congestion avoidance operation to the specific pedestrian terminal 1. In this case, the roadside apparatus 3 may be configured to select the pedestrian terminal(s) 1 which is to perform the congestion avoidance operation.

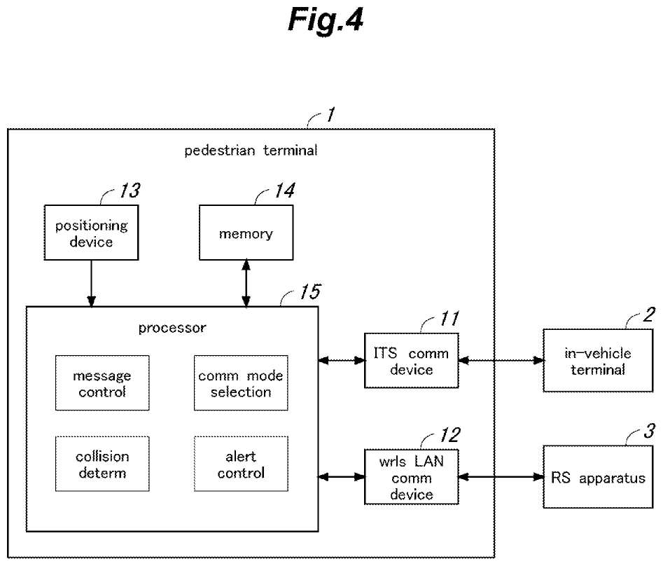

Next, a schematic configuration of a pedestrian terminal 1 according to a first embodiment will be described. FIG. 4 is a block diagram showing a schematic configuration of a pedestrian terminal 1.

The pedestrian terminal 1 includes an ITS communication device 11, a wireless LAN communication device 12, a positioning device 13, a memory 14, and a processor 15.

The ITS communication device 11 broadcasts messages to in-vehicle terminals 2 through ITS communications (pedestrian-to-vehicle communications), and also receives messages transmitted from the in-vehicle terminals 2.

The wireless LAN communication device 12 transmits messages to the in-vehicle terminals 2 via a roadside apparatus 3 by using a wireless LAN communication system such as a WiFi (registered trademark) communication system.

The positioning device 13 measures the position of the PDS terminal by using a satellite positioning system such as GPS (Global Positioning System) or QZSS (Quasi-Zenith Satellite System), to thereby acquire the position data (latitude, longitude) of the pedestrian terminal 1.

The memory 14 stores map information, programs executable by the processor 15, and other information.

The processor 15 performs various processing operations related to pedestrian support by executing the programs stored in the memory 14. In the present embodiment, the processor 15 performs each of the operations for message control, communication mode selection, collision determination, and alert control.

In the message control operation, the processor 15 controls the transmission of a message including pedestrian information such as a terminal ID and position data. In this operation, the ITS communication device 11 or the wireless LAN communication device 12 transmits a message using a selected communication mode according to the selection result in the communication mode selection operation.

In the communication mode selection operation, the processor 15 selects a communication mode (direct communication mode or indirect communication mode) used in the transmission of a message to the in-vehicle terminal 2. In the present embodiment, the processor 15 performs the congestion avoidance operation by switching the communication mode from the direct communication mode to the indirect communication mode in response to an instruction of congestion avoidance operation from the roadside apparatus 3. Furthermore, the processor 15 determines whether or not the pedestrian terminal 1 is allowed to (or should) perform the congestion avoidance operation according to the status and attributes of the pedestrian carrying the pedestrian terminal. When determining that the pedestrian terminal can perform the congestion avoidance operation, the processor 15 switches the communication mode.

The processor 15 may determine the status of the pedestrian based on the pedestrian's position data acquired by the positioning device 13, the detection results of other sensors (acceleration sensor, direction sensor, or other sensors, not shown) and map information stored in the memory 14. Furthermore, based on the attribute data of the pedestrian carrying the pedestrian terminal pre-stored in the memory 14, the processor 15 can determine the attribute of the pedestrian.

In the collision determination operation, the processor 15 determines whether or not there is a risk of collision between the pedestrian and a vehicle based on the vehicle's position data included in the vehicle information acquired from the in-vehicle terminal 2, the pedestrian's position data acquired by the positioning device 13, and other information.

In the alert control operation, when determining that there is a risk of collision in the collision determination operation, the processor 15 performs performs controls to provide a predetermined alert to the pedestrian (for example, by using voice or vibration).

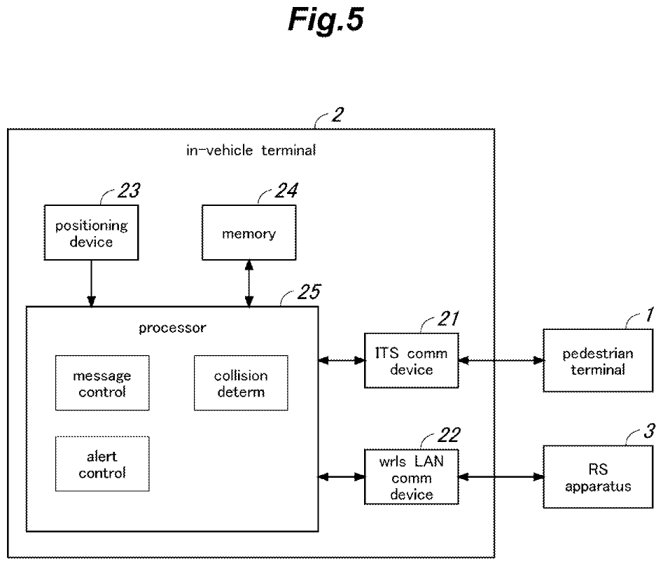

Next, a schematic configuration of an in-vehicle terminal 2 according to the first embodiment. FIG. 5 is a block diagram showing a schematic configuration of an in-vehicle terminal 2.

The in-vehicle terminal 2 includes an ITS communication device 21, a wireless LAN communication device 22, a positioning device 23, a memory 24, and a processor 25.

The in-vehicle terminal 2 broadcasts messages to pedestrian terminals 1 through ITS communications (pedestrian-to-vehicle communications), and also receives messages transmitted from the pedestrian terminals 1.

The wireless LAN communication device 22 transmits messages to the pedestrian terminals 1 via a roadside apparatus 3 by using a wireless LAN communication system such as a WiFi (registered trademark) communication system.

The positioning device 23 measures the position of the in-vehicle terminal by using a satellite positioning system such as GPS or QZSS, to thereby acquire the position data (latitude, longitude) of the in-vehicle terminal 2.

The memory 24 stores map information, programs executable by the processor 25, and other information.

The processor 25 performs various processing operations related to driver support by executing the programs stored in the memory 24. In the present embodiment, the processor 25 performs each of the operations for message control, collision determination, and alert control.

In the message control operation, the processor 25 controls the transmission of a message including vehicle information such as a terminal ID and position data. In this operation, the ITS communication device 21 or the wireless LAN communication device 22 transmits a message using a selected communication mode according to the selection result in the communication mode selection operation.

In the collision determination operation, the processor 25 determines whether or not there is a risk of collision between the vehicle and a pedestrian based on the pedestrian's position data included in the pedestrian information acquired from the pedestrian terminal 1, the vehicle's position data acquired by the positioning device 23, and other information.

In the alert control operation, when determining that there is a risk of collision in the collision determination operation, the processor 25 performs controls to provide a predetermined alert to the driver (for example, by using voice or image display).

In the present embodiment, when there is predicted congestion in ITS communications, the pedestrian terminal 1 performs indirect communications to avoid congestion in the ITS communications, thereby ensuring the stability of vehicle-to-vehicle communications. However, in-vehicle terminals 2 may also perform indirect communications when there is predicted congestion in ITS communications. For example, when a specific vehicle such as an emergency vehicle passes by, the in-vehicle terminals 2 of other vehicles may perform indirect communications to thereby ensure the stability of vehicle-to-vehicle communications performed by the in-vehicle terminal 2 of the specific vehicle.

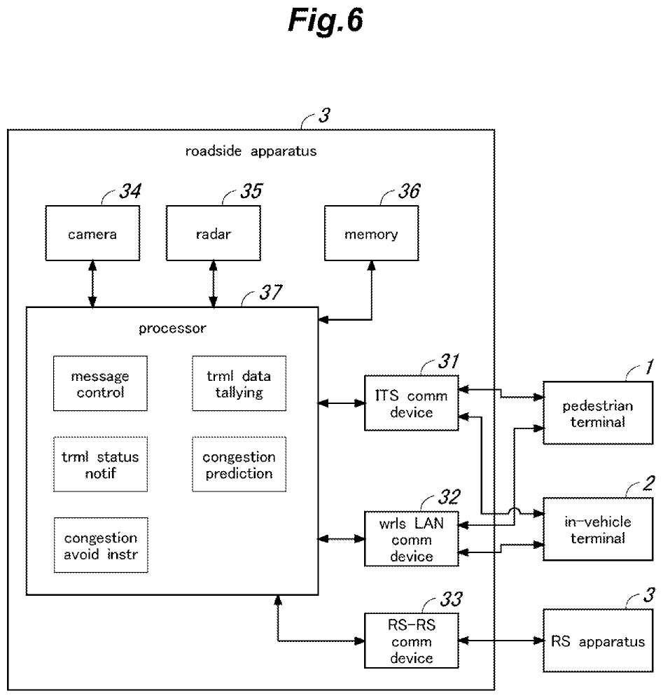

Next, a schematic configuration of a roadside apparatus 3 according to the first embodiment will be described. FIG. 6 is a block diagram showing a schematic configuration of a roadside apparatus 3.

The roadside apparatus 3 includes an ITS communication device 31 (first communication device), a wireless LAN communication device 32, a roadside-to-roadside communication device 33 (second communication device), a camera 34, a radar 35, a memory 36, and a processor 37.

The ITS communication device 31 broadcasts messages to pedestrian terminals 1 and in-vehicle terminals 2 through ITS communications (roadside-to-pedestrian communications, roadside-to-vehicle communications), and also receives messages transmitted from the pedestrian terminals 1 and the in-vehicle terminals 2.

The wireless LAN communication device 32 receives messages transmitted from the pedestrian terminals 1 and the in-vehicle terminals 2 by using a wireless LAN communication system such as a WiFi (registered trademark) communication system, and broadcasts the received messages to the pedestrian terminals 1 and the in-vehicle terminals 2.

The roadside-to-roadside communication device 33 communicates with an adjacent roadside apparatus(es) 3 via a dedicated roadside network (wired or wireless network) or any other network such as a cellular communication network.

The camera 34 captures images of a road(s) around the roadside apparatus, and can acquire position data of each mobile body located on the road through image recognition performed on the captured image. The radar 35 detects a mobile body (pedestrian or vehicle) located on the road(s) around the roadside apparatus by detecting the reflected waves of the radiated radio waves, to thereby measure the direction and distance of the mobile body from the roadside apparatus.

The memory 36 stores programs executable by the processor 37, and other information.

The processor 37 performs various processing operations by executing the programs stored in the memory 36. In the present embodiment, the processor 37 performs each of the operations for message control, terminal data tallying, terminal status notification, communication congestion prediction, and congestion avoidance instruction.

In the message control operation when using the wireless LAN communications, upon receiving messages transmitted from the pedestrian terminal 1 and/or the in-vehicle terminal 2 at the wireless LAN communication device 32, the processor 37 transmits the message from the wireless LAN communication device 32 to the pedestrian terminal 1 or the in-vehicle terminal 2. In the message control operation when using the ITS communications, the processor 37 receives messages transmitted from the pedestrian terminal 1 and/or the in-vehicle terminal 2 at the ITS communication device 31.

In the terminal data tallying operation, the processor 37 counts the terminal IDs included in the messages received from pedestrian terminals 1, to thereby acquire a current terminal number; that is, the total number of the pedestrian terminals 1 currently located in the communication area of the roadside apparatus 3.

Although the roadside apparatus 3 can detect pedestrians and vehicles present around the roadside apparatus based on the detection results of the camera 34 and the radar 35, some pedestrians may not carry their pedestrian terminals 1, and such pedestrians without the pedestrian terminals 1 have no erect on the occurrence of congestion in the ITS communications. Thus, it is not necessary to count those pedestrians having no pedestrian terminals 1 by using the detection results of the camera 34 and the radar 35. However, the use of the detection results of the camera 34 and the radar 35 can improve the accuracy of the position data of each pedestrian terminal 1.

In the terminal data tallying operation, based on pedestrian information (such as position, direction, speed) included in the message received from each pedestrian terminal 1 and map information, the processor 37 acquires an entering terminal number for each of the adjacent roadside apparatuses 3 (at a corresponding, one of the adjacent intersections); that is, the total number of pedestrian terminals 1 that are predicted to enter the communication area of each adjacent roadside apparatus 3 from the communication area of the roadside apparatus 3 itself.

Moreover, in the terminal data tallying operation, the processor 37 acquires a leaving terminal number; that is, the total number of pedestrian terminals 1 that are predicted to leave the communication area of the roadside apparatus 3 by a predetermined future time. The leaving terminal number is the sum of the number of pedestrian terminals 1 which are predicted to leave the communication area of the roadside apparatus in the respective directions; that is, the sum of the entering terminal numbers for the respective adjacent roadside apparatuses 3 (intersections).

In the terminal status notification operation, the processor 37 notifies the adjacent roadside apparatuses 3 of terminal status information about the status of each pedestrian terminal 1 located around the roadside apparatus 3. In the present embodiment, the roadside apparatus 3 transmits, as the terminal status information, terminal movement information indicating the movement directions of the pedestrian terminals 1 to the adjacent roadside apparatuses 3. Specifically, the roadside apparatus 3 generates a message (including the entering terminal number acquired in the terminal data tallying operation) for each adjacent roadside apparatus 3, and transmits the message to the roadside apparatus 3 from the roadside-to-roadside communication device 33.

In the communication congestion prediction operation, the processor 37 determines whether or not there is predicted congestion in the ITS communications at a predetermined future time based on the terminal status information received from the adjacent roadside apparatuses 3. In the present embodiment, the roadside apparatus 3 receives, as the terminal status information, terminal movement information indicating the movement directions of the pedestrian terminals 1 (or entering terminal numbers) from the adjacent roadside apparatuses 3 (information source roadside apparatuses). Then, based on the terminal movement information, the roadside apparatus 3 acquires the predicted terminal number; that is, the total number of pedestrian terminals 1 located in the communication area of the roadside apparatus 3 at a predetermined future time, and when the predicted terminal number exceeds a predetermined threshold value (e.g., 300), the roadside apparatuses 3 determines that there is predicted congestion in the ITS communication.

In this operation, the roadside apparatus 3 acquires the predicted terminal number by tallying the current terminal number and the leaving terminal numbers acquired in the terminal data tallying operation and the entering terminal numbers acquired from the adjacent roadside apparatuses 3 (information source roadside apparatuses). Specifically, the roadside apparatus 3 calculates the predicted terminal number by adding the entering terminal number to the current terminal number and then subtracting the leaving terminal number from the resulting number.

When determining that there is predicted congestion in the ITS communications in the communication congestion prediction operation, in the congestion avoidance instruction operation, the processor 37 transmits to the pedestrian terminals 1 an instruction for congestion avoidance operation to restrict the ITS communications. Specifically, the processor 37 transmits a message from the ITS communication device 31 to the pedestrian terminals 1, the message including, as information for instructing congestion avoidance operation, switching instruction information; that is, an instruction to switch the communication mode from the direct communication mode to the indirect communication mode.

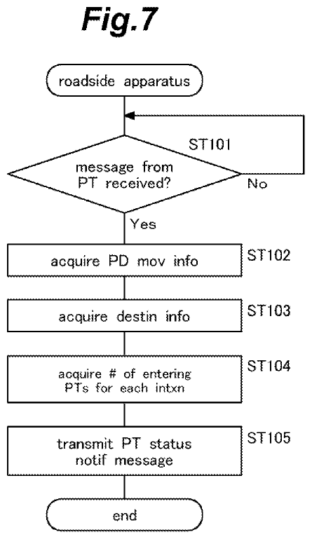

Next, operations for terminal status notification performed by an information source roadside apparatus 3 according to the first embodiment will be described. FIG. 7 is a flow chart showing an operation procedure of operations for terminal status notification performed by an information source roadside apparatus 3.

First, when receiving messages from the pedestrian terminals 1 at the ITS communication device 31 (Yes in ST101), the information source roadside apparatus 3 acquires pedestrian movement information (i.e., information about on which road, in which direction, and at what speed each pedestrian is moving) based on pedestrian information (position, direction, speed, and other data of each pedestrian) included in messages received from the pedestrian terminals 1 and map information (ST102).

Next, based on the pedestrian movement information, the information source roadside apparatus 3 acquires destination information for each pedestrian, the destination information including (i) information on an intersection area, i.e., a communication area of a roadside apparatus 3 installed at an intersection which the pedestrian is expected to reach by a predetermined future time and (ii) information on the roadside apparatus 3 of the intersection (ST103).

Next, the information source roadside apparatus 3 tallies destination information for the respective pedestrians, and acquires an entering terminal number (terminal movement information) for each of the roadside apparatuses at the adjacent destination intersections; that is, the number of pedestrian terminals 1 which are predicted to move from the communication area of the information source roadside apparatus 3 into a communication area of each adjacent roadside apparatus 3 (ST104).

Next, the information source roadside apparatus 3 generates a terminal status notification message for each of the roadside apparatuses 3 at the adjacent intersections. The information source roadside apparatus 3 transmits the generated message from the roadside-to-roadside communication device 33 to each of the roadside apparatuses 3 at the adjacent intersections (ST105). The terminal status notification message includes an entering terminal number, the number of the terminals which are predicted to enter the communication area of each roadside apparatus 3.

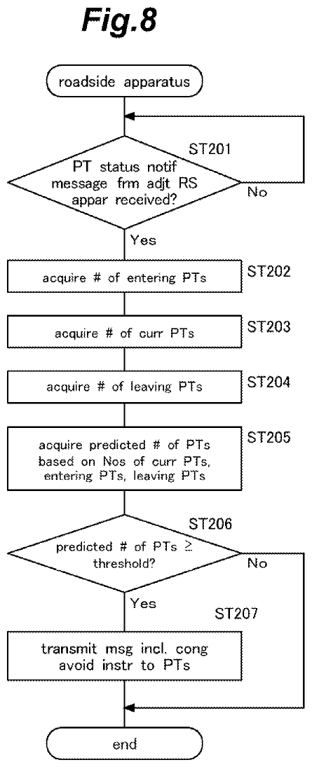

Next, operations performed by an information destination roadside apparatus 3 according to the first embodiment when there is predicted communication congestion will be described. FIG. 8 is a flow chart showing an operation procedure of operations performed by an information destination roadside apparatus 3 when there is predicted communication congestion.

When receiving a terminal status notification message from the roadside apparatuses 3 at the adjacent intersection at the roadside-to-roadside communication device 33 (Yes in ST201), the information destination roadside apparatus 3 acquires an entering terminal number included in the message; that is, the total number of pedestrian terminals 1 which are predicted to move from the communication area of the adjacent information source roadside apparatus 3 into the communication area of the information destination roadside apparatus (ST202).

Next, the information destination roadside apparatus 3 counts the terminal IDs included in the messages received from the pedestrian terminals 1, to thereby acquire a current terminal number; that is, the total number of pedestrian terminals 1 currently located in the communication area of the information destination roadside apparatus 3 (ST203).

Next, based on the pedestrian movement information, the information destination roadside apparatus 3 acquires a leaving terminal number; that is, the total number of pedestrian terminals 1 which are predicted to leave the communication area of the information destination roadside apparatus 3 by a predetermined future time (ST204).

Next, the information destination roadside apparatus 3 acquires a predicted terminal number based on the current terminal number, the entering terminal number, and the leaving terminal number (ST205). Specifically, the information destination roadside apparatus 3 calculates the predicted terminal number by adding the entering terminal number to the current terminal number and then subtracting the leaving terminal number from the resulting number.

Next, the information destination roadside apparatus 3 determines whether or not the a predicted terminal number is equal to or greater than a predetermined threshold value (ST206). The predetermined threshold value used for the determination is the number of pedestrian terminals 1 when the occurrence of congestion in the ITS communications exceeds an acceptable range.

When determining that the predicted terminal number exceeds the threshold value (Yes in ST206), the information destination roadside apparatus 3 generates a message including an instruction for congestion avoidance operation. The information destination roadside apparatus 3 transmits the generated message from the ITS communication device 31 to the pedestrian terminals 1 (S1207). When determining that the predicted terminal number is less than the threshold value (No in ST206), the process ends.

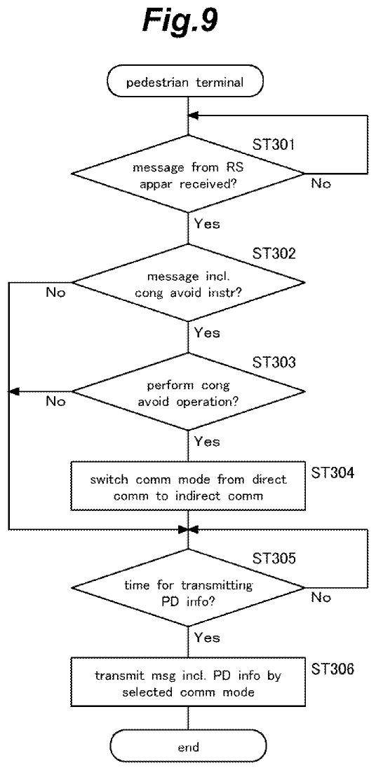

Next, a congestion avoidance operation performed by a pedestrian terminal 1 according to the first embodiment will be described. FIG. 9 is a flow chart showing an operation procedure of a congestion avoidance operation performed by a pedestrian terminal 1.

When receiving a message transmitted from the roadside apparatus 3 at the ITS communication device 11 (Yes in ST301), the pedestrian terminal 1 determines whether or not the message received from the roadside apparatus 3 includes an instruction for congestion avoidance operation (ST302).

When the message received from the roadside apparatus 3 contains the instruction for congestion avoidance operation (Yes in ST302), then the pedestrian terminal 1 determines whether or not the pedestrian terminal should perform the congestion avoidance operation based on a status and an attribute of the pedestrian carrying the pedestrian terminal 1.

When determining that the congestion avoidance operation should be performed (Yes in ST303), the pedestrian terminal 1 performs the congestion avoidance operation; that is, switches the communication mode from the direction communication mode to the indirect communication mode (ST304).

When determining that the congestion avoidance operation should not be performed (No in ST303), or when the message received from the roadside apparatus 3 does not contain an instruction for congestion avoidance operation (No in ST302), the pedestrian terminal 1 does not perform any operation and the communication mode remains the direct communication mode.

Next, when it is a time for transmitting pedestrian information (Yes in ST305), the pedestrian terminal 1 transmits a message including the pedestrian information by using the selected communication mode (ST306). That is, when the direct communication mode is selected, the pedestrian terminal 1 transmits a message from the ITS communication device 11 to in-vehicle terminals 2, and when the indirect communication mode is selected, the pedestrian terminal 1 transmits a message from the wireless LAN communication device 12 to in-vehicle terminals 2 via a roadside apparatus(es) 3.

In the present embodiment, a roadside apparatus 3 performs necessary operations related to communication congestion control; that is, operations such as a communication congestion prediction operation and a congestion avoidance instruction operation provided to pedestrian terminals 1. However, a management device (edge server) which is connected to the roadside apparatus 3 via a network may perform such necessary operations related to communication congestion control.

FIGS. 7, 8 and 9 show that, when there is predicted congestion in the ITS communication, a pedestrian terminal 1 switches the communication mode from the direct communication mode (using ITS communications) to the indirect communication mode (using wireless LAN communications). However, in the case of a decrease in the number of nearby pedestrian terminals 1 and thus in the possibility of the occurrence of congestion in the ITS communications, the pedestrian terminal 1 performs a return operation in which the communication mode is returned to the original direct communication mode (using ITS communications).

For this operation, a second threshold value (e.g., 200) is preset as another threshold value to be compared with the predicted terminal number in the communication area of a roadside apparatus 3, where the second threshold is smaller than the first threshold (e.g., 300) used in determining to perform the congestion avoidance operation, so that the roadside apparatus 3 can use the second threshold value to determine Whether or not to perform the return operation. Specifically, when determining that the predicted terminal number becomes less than the second threshold value, the pedestrian terminal 1 performs the return operation by switching the communication mode from the indirect communication mode back to the direct communication mode.

Furthermore, When a predetermined time (e.g., 10 minutes) has elapsed after the switching of the communication mode from the direct communication mode to the indirect communication mode, the pedestrian terminal 1 may perform the return operation by returning the communication mode to the direct communication mode. In this case, when determining that the congestion status in the ITS communications is still not improved after the return operation, the pedestrian terminal 1 may switch the communication mode to the indirect communication mode again.

In the present embodiment, in order to assist the driving of autonomous driving vehicles, a roadside apparatus constantly performs communication congestion control to maintain a proper communication environment which minimizes difficulty with driving of autonomous driving vehicles. However, the roadside apparatus may be configured to detect the approach of an autonomous driving vehicle and perform communication congestion control only when the autonomous driving vehicle is passing by, to prevent the occurrence of communication congestion related to that autonomous driving vehicle.

When greater emphasis is placed on ensuring the stability of vehicle-to-vehicle communications, the roadside apparatus 3 may be configured such that, in the case where there are many vehicles (specifically, when the total number of in-vehicle terminals 2 located in its communication area exceeds a predetermined threshold value), the roadside apparatus 3 constantly performs communication congestion control, whereas, in the case where there are not so many vehicles (specifically, when the total number of in-vehicle terminals 2 located in its communication area is less than the predetermined threshold value), the roadside apparatus 3 performs communication congestion control only when a specific vehicle such as an autonomous driving vehicle or an emergency vehicle passes by.

### First Variation of First Embodiment

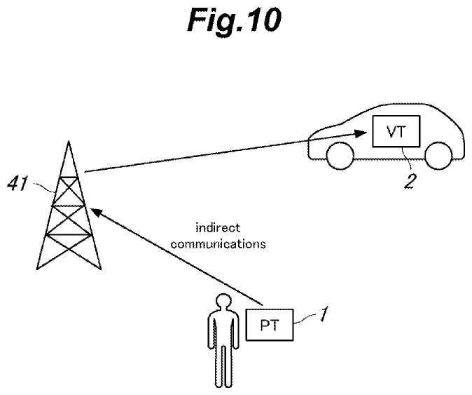

Next, a first variation of the first embodiment of the present invention will be described. Except for what will be discussed here, the first variation is the same as the above-described first embodiment. FIG. 10 is an explanatory diagram showing an outline of a communication system according to the first variation of the first embodiment.

In the first embodiment, a pedestrian terminal 1 performs, as a congestion avoidance operation, indirect communications via a roadside apparatus 3. However, in the first variation, a pedestrian terminal 1 performs, as a congestion avoidance operation, indirect communications via a base station of a cellular communication system such as a LTE (Long Term Evolution) communication system (cellular V2X).

The configuration of a pedestrian terminal 1 according to the first variation is different from that of the first embodiment (see FIG. 4) in that a cellular communication device is provided as a communication device for indirect communications, in place of the wireless LAN communication device 12 in the first embodiment. Examples of indirect communication devices used in the pedestrian terminal 1 other than a wireless LAN communication device or a cellular communication device, include a Bluetooth (registered trademark) communication device, a BLE (Bluetooth Low Energy) communication device, and/or an LPWA (Low Power, Wide Area) communication device.

### Second Variation of First Embodiment

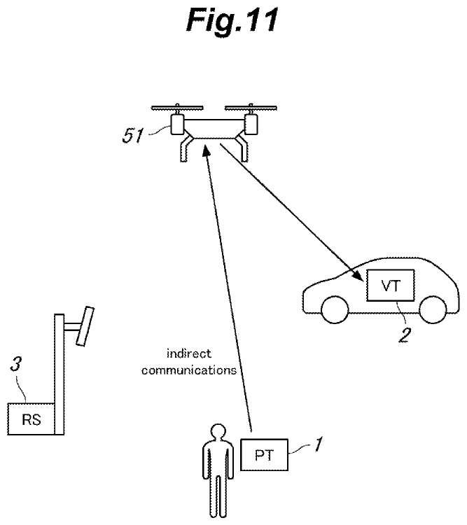

Next, a communication system according to a second variation of the first embodiment of the present invention will be described. Except for what will be discussed here, the second variation is the same as the above-described first embodiment. FIG. 11 is an explanatory diagram showing an outline of a communication system according to the second variation of the first embodiment.

In the first embodiment, a roadside apparatus 3 is provided with a communication device for indirect communications, and indirect communications are performed between terminals via the roadside apparatus 3. However, in the second variation, a drone 51 is provided with a communication device for indirect communications, and when a roadside apparatus 3 determines that there is predicted congestion in the ITS communications, the drone 51 moves to an area around the roadside apparatus 3 so that pedestrian terminals 1 can perform indirect communications via the drone 51. As a result, even when an existing roadside apparatus 3 is not provided with a communication device for indirect communications, pedestrian terminals 1 can perform indirect communications in the peripheral area of the roadside apparatus 3.

The flying body provided with a communication device for indirect communications is not limited to the drone 51, and may be any other suitable flying body such as a balloon. Such a mobile body provided with a communication device for indirect communications may be a robot such as a humanoid robot or a vehicle-type robot, not a flying mobile body.

### Third Variation of First Embodiment

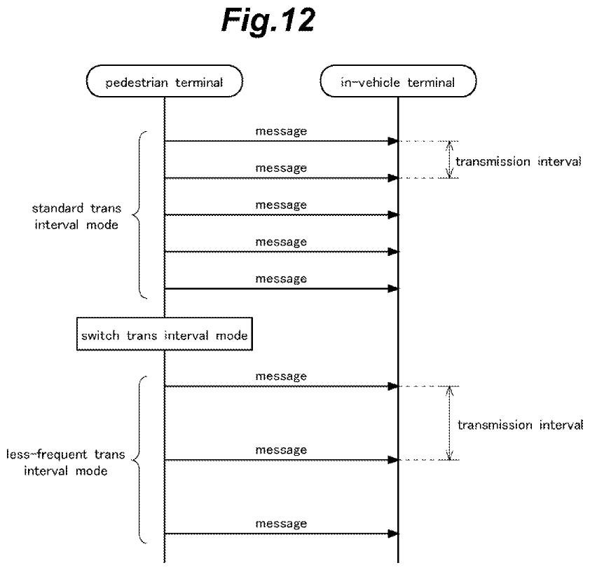

Next, a third variation of the first embodiment of the present invention will be described. Except for what will be discussed here, the third variation is the same as the above-described first embodiment. FIG. 12 is an explanatory diagram showing an outline of a communication system according to the third variation of the first embodiment.

In the first embodiment, as a congestion avoidance operation, a pedestrian terminal 1 switches the communication mode from the direct communication mode (using ITS communications) to the indirect communication mode (using wireless LAN communications). However, in the third variation, as a congestion avoidance operation, a pedestrian terminal 1 makes intervals at which the PDT transmits messages via the ITS communications, longer than a standard message transmission interval. For example, when the standard message transmission interval is 100 ms, the pedestrian terminal 1 changes the message transmission interval to one second. This can result in a reduction in the communication traffic in a network for ITS communications, thereby avoiding congestion in the ITS communications. It should be noted that a pedestrian terminal 1 periodically transmits messages including pedestrian information (such as position data) at predetermined intervals, in order to notify the surroundings of the presence of the pedestrian.

In the third variation, the pedestrian terminal 1 determines whether or not to perform the congestion avoidance operation based on the status and/or attribute of a pedestrian who carries it, in a similar manner to the first embodiment. When determining that it should not perform the congestion avoidance operation, the pedestrian terminal 1 sets a transmission interval mode to a standard transmission interval mode for ITS communications, whereas, when determining that it should perform the congestion avoidance operation, the pedestrian terminal 1 sets the transmission interval mode to a less-frequent transmission interval mode in which the transmission interval is made longer than that in the standard transmission interval mode. For example, in the case of a pedestrian terminal 1 carried by a pedestrian with a high risk of collision (e.g., a pedestrian located on a roadway), even when receiving an instruction for congestion avoidance operation from the roadside apparatus 3, the pedestrian terminal 1 remains in the standard transmission interval mode. In other cases, in the case of a pedestrian terminal 1 carried by a pedestrian having a low risk of collision (e.g., a pedestrian located on a sidewalk), upon receiving an instruction for congestion avoidance operation from the roadside apparatus 3, the pedestrian terminal 1 switches the transmission interval mode to the less-frequent transmission interval mode.

In other embodiments, in the case of a pedestrian terminal 1 carried by a pedestrian with a high risk of collision, the frequency of transmitting messages may vary depending on the attribute of the pedestrian. For example, for a child who is likely to take unpredictable sudden risky actions such as running into a road, the pedestrian terminal 1 may be set to transmit messages more frequently, and for an elderly person who is unlikely to take sudden actions, the pedestrian terminal 1 may be set to transmit messages less frequently.

The configuration of a pedestrian terminal 1 according to the third variation is different from that of the first embodiment (see FIG. 4) in that the pedestrian terminal 1 does not require a communication device for indirect communications, i.e., the wireless LAN communication device 12.

### Fourth Variation of First Embodiment

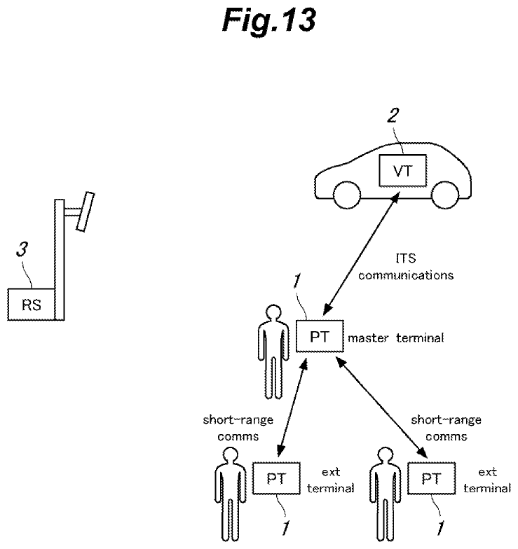

Next, a fourth variation of the first embodiment of the present invention will be described. Except for what will be discussed here, the fourth variation is the same as the above-described first embodiment. FIG. 13 is an explanatory diagram showing an outline of a communication system according to a fourth variation of the first embodiment.

In the first embodiment, as a congestion avoidance operation, a pedestrian terminal 1 switches the communication mode from the direct communication mode (using ITS communications) to the indirect communication mode (using wireless LAN communications). However, in the fourth variation, a congestion avoidance operation is achieved by grouping a plurality of pedestrian terminals 1 into one or more groups, each group consisting of one pedestrian terminal 1 used as the “master terminal (representative terminal)”, and the remaining pedestrian terminals 1 used as “extension terminals (in-group terminals)”, where the pedestrian terminal 1 as the master terminal performs ITS communications, and the pedestrian terminals 1 as extension terminals stops ITS communications. This configuration restricts the number of pedestrian terminals 1 which perform ITS communications, thereby reducing the communication traffic in a network for ITS communications to minimize congestion in the ITS communications. However, in the case of a pedestrian terminal 1 carried by a pedestrian who is likely to take risky actions (e.g., a pedestrian having historical records of risky actions such as running into a road), the pedestrian terminal 1, in addition to the master terminal (representative terminal), may be allowed to perform the ITS communications.

In the fourth variation, short-range communications are performed between a pedestrian terminal 1 as the master terminal and pedestrian terminals 1 as extension terminals. As a result, a pedestrian terminal 1 grouped as an extension terminal can exchange vehicle information and pedestrian information with an in-vehicle terminal(s) 2 via the master pedestrian terminal 1.

Preferably, when pedestrians of a group gather together, a pedestrian terminal 1 carried by a pedestrian in the group located near the outside of the gathered pedestrian group is set as the master terminal, and pedestrian terminals carried by pedestrians located on the relatively inner side of the gathered pedestrian group are set as the extension terminals. As a result, the pedestrian who is located near the outside of the gathered pedestrian group and has a relatively high risk of collision, can achieve increased safety by carrying the master pedestrian terminal, which is allowed to perform ITS communications, whereas pedestrians who are located on the relatively inner side of the gathered pedestrian group, can remain relatively safe even if they carry extension pedestrian terminals, which are not allowed to perform ITS communications. In some cases, pedestrians may be classified to one group representative and the remaining group members, which are registered as pedestrian attributes, so that pedestrian terminals 1 carried by those pedestrians can be grouped into the master terminal and the extension terminals based on their registered attributes. However, in the case of a pedestrian terminal 1 carried by a pedestrian who is located on the relatively inner side of the gathered pedestrian group, but is likely to take risky actions (e.g., a pedestrian having historical records of risky actions such as running into a road), the pedestrian terminal 1 may be allowed to perform the ITS communications, in addition to the master terminal (representative terminal).

The configuration of a pedestrian terminal 1 according to the fourth variation is different from that of the first embodiment (see FIG. 4) in that a short-range communication device is provided, in place of the wireless LAN communication device 12 in the first embodiment.

### Second Embodiment

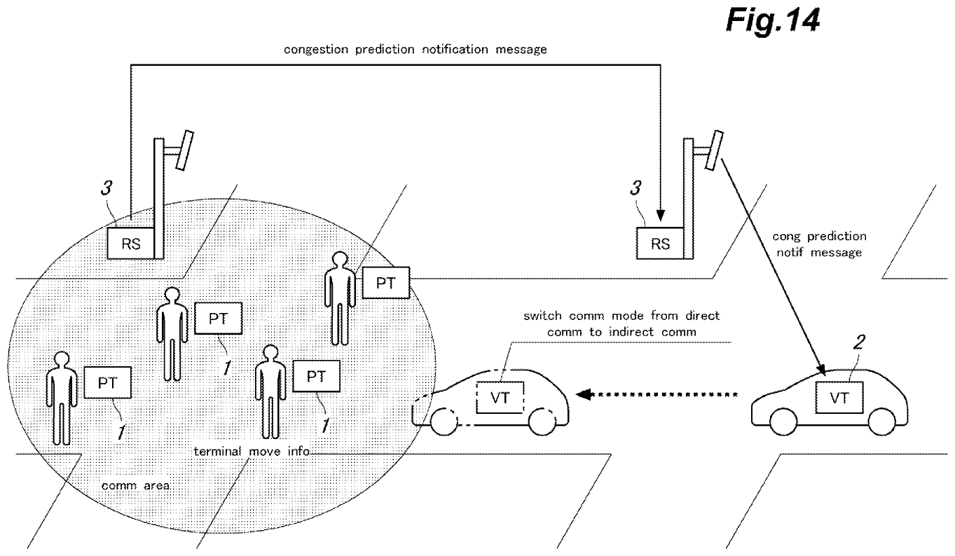

Next, a second embodiment of the present invention will be described. Except for what will be discussed here, the second embodiment is the same as the above-described first embodiment. FIG. 14 is a diagram showing a general configuration of a communication system according to the second embodiment.

In the first embodiment, when determining that there is predicted congestion in the ITS communications, a pedestrian terminal 1 performs the congestion avoidance operation by switching the communication mode from the direct communication mode to the indirect communication mode. However, in the present embodiment, when determining that there is predicted congestion in the ITS communications, an in-vehicle terminal 2 performs a congestion avoidance operation.

In this particular embodiment, a plurality of roadside apparatuses 3 cooperatively operate to transmit congestion prediction information indicating that there is predicted congestion in the IST communications, to an in-vehicle terminal 2 carried by a vehicle currently located away from an area where the communication congestion is predicted to occur (predicted congestion occurring area), so that the in-vehicle terminal 2 can switch the communication mode from the indirect communication mode to the direct communication mode by the time when the vehicle enters a predicted congestion occurring point. As a result, the in-vehicle terminal 2 is allowed to stably exchange messages with other in-vehicle terminals 2 and or PTD terminals 1 through indirect communications, regardless of the occurrence of congestion in the ITS communications.

In addition, in the present embodiment, the roadside apparatus 3 which is the source of congestion prediction information transmits its terminal ID together with the congestion prediction information to the in-vehicle terminal 2. As a result, the in-vehicle terminal 2 can recognize, based on the terminal ID, an area around the information source roadside apparatus 3; that is, a predicted congestion occurring area where the communication congestion is predicted to occur, so that the in-vehicle terminal 2 can switch the communication mode by the time when the vehicle enters the predicted congestion occurring area.

Alternatively, instead of switching the communication mode, the roadside apparatus 3 may provide the in-vehicle terminal 2 with route guidance information about a route which can avoid an area where congestion in the ITS communications is predicted to occur. The roadside apparatus 3 may provide the route guidance information only to a specific vehicle such as a vehicle of a driving school, a vehicle with a beginner driver's mark, a vehicle driven by an elderly person, a vehicle driven by a driver who is not good at driving.

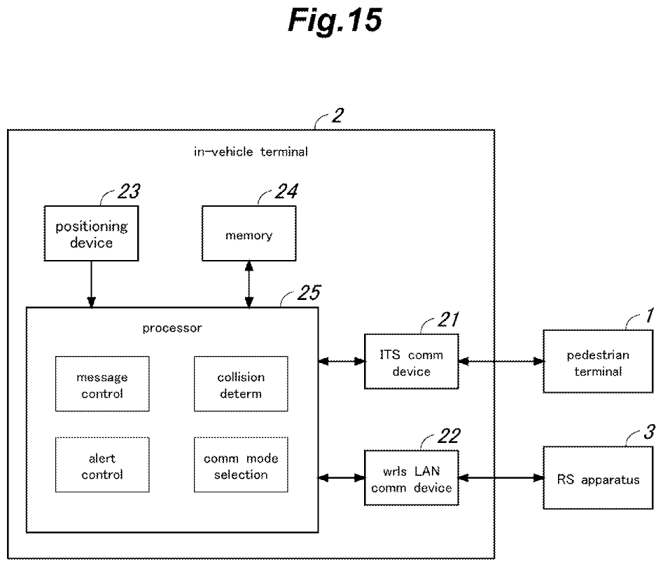

Next, a schematic configuration of an in-vehicle terminal 2 according to the second embodiment will be described. FIG. 15 is a block diagram showing a schematic configuration of an in-vehicle terminal 2 of the second embodiment.

The in-vehicle terminal 2 includes an ITS communication device 21, a wireless LAN communication device 22, a positioning device 23, a memory 24, and a processor 25, as in the first embodiment (FIG. 5). The processor 25 performs a communication mode selection operation, in addition to the operations for message control, collision determination, and alert control as in the first embodiment.

In the communication mode selection operation, the processor 25 selects the communication mode (either the direct communication mode or the indirect communication mode) used to transmit messages to a pedestrian terminal(s) 1. In the present embodiment, upon receiving congestion prediction information indicating that there is predicted congestion in the IST communications from roadside apparatuses 3, the in-vehicle terminal 2 performs the congestion avoidance operation by switching the communication mode from the indirect communication mode to the direct communication mode.

The wireless LAN communication device 22 transmits messages to the pedestrian terminals 1 via a roadside apparatus 3 by using a wireless LAN communication system such as a WiFi (registered trademark) communication system.

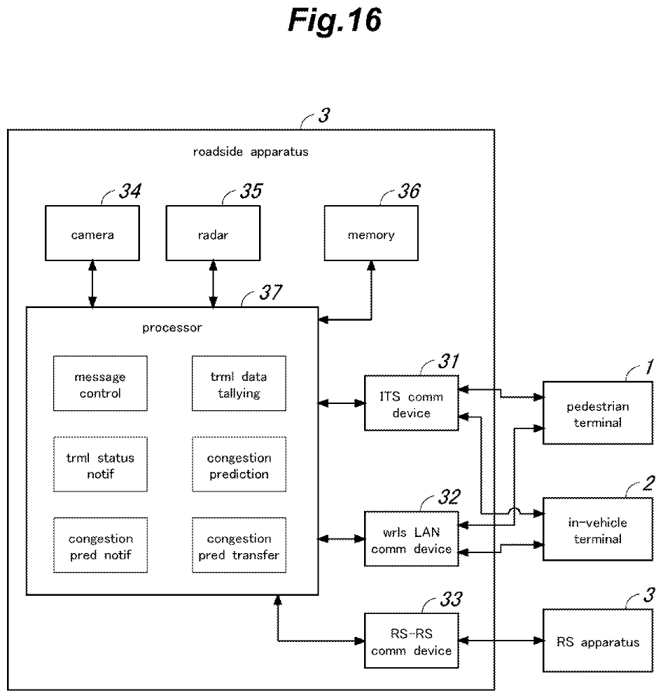

Next, a schematic configuration of a roadside apparatus 3 according to the second embodiment will be described. FIG. 16 is a block diagram showing a schematic configuration of a roadside apparatus 3.

The roadside apparatus 3 includes an ITS communication device 31 (first communication device), a wireless LAN communication device 32, a roadside-to-roadside communication device 33 (second communication device), a camera 34, a radar 35, a memory 36, and a processor 37 as in the first embodiment (See FIG. 6). The processor 37 performs a congestion prediction notification operation and a congestion prediction transfer operation, in addition to performing the operations for message control, terminal data tallying, terminal status notification, communication congestion prediction as in the first embodiment.

When determining that there is predicted congestion in the ITS communications in the communication congestion prediction operation, the processor 37 performs the congestion prediction notification operation to provide congestion prediction information indicating that there is predicted congestion, to an adjacent roadside apparatus(es) 3. Specifically, the processor 37 transmits a message including congestion prediction information from the roadside-to-roadside communication device 33 to the adjacent roadside apparatus(es) 3.

In the congestion prediction transfer operation, the processor 37 transfers the congestion prediction information received from an adjacent roadside apparatus(es) 3 to in-vehicle terminals 2 located in the ITS communication area of the roadside apparatus 3. Specifically, when the roadside-to-roadside communication device 33 receives a message including the congestion prediction information from the adjacent roadside apparatus(es) 3, the roadside apparatus 3 transmits the message including the congestion prediction information from the ITS communication device 31 to the in-vehicle terminals 2.

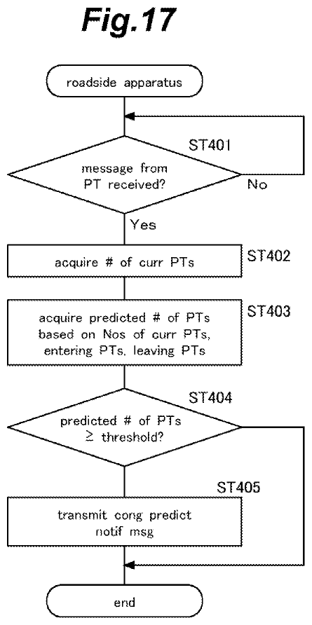

Next, operations performed by a roadside apparatus 3 according to the second embodiment when there is predicted communication congestion will be described. FIG. 17 is a flow chart showing an operation procedure of operations performed by a roadside apparatus 3 when there is predicted communication congestion.

First, when receiving messages from the pedestrian terminals 1 at the ITS communication device 31 (Yes in ST401), the roadside apparatus 3 counts the terminal IDs included in the messages received from the pedestrian terminals 1, to thereby acquire a current terminal number; that is, the total number of pedestrian terminals 1 currently located in the communication area of the roadside apparatus 3 (ST402).

Next, the roadside apparatus 3 acquires a predicted terminal number based on the current terminal number, an entering terminal number, and a leaving terminal number (ST403). Specifically, the roadside apparatus 3 calculates the predicted terminal number by adding the entering terminal number to the current terminal number and then subtracting the leaving terminal number from the resulting number. This tallying calculation involves the processing operations of ST201 to ST202, ST204, and ST205 in the first embodiment (see FIG. 8).

Next, the roadside apparatus 3 determines whether or not the predicted terminal number is equal to or greater than a predetermined threshold value (ST404). The predetermined threshold value used for the determination is the number of pedestrian terminals 1 when the occurrence of congestion in the ITS communications exceeds an acceptable range.

When determining that the predicted terminal number exceeds the threshold value (Yes in ST404), the roadside apparatus 3 generates a congestion prediction notification message. The roadside apparatus 3 transmits the generated message from the roadside-to-roadside communication device 33 to a roadside apparatus(es) at an adjacent intersection(s) (ST405). The congestion prediction notification message includes congestion prediction information indicating that there is predicted congestion in the ITS communications, and the terminal ID of the roadside apparatus (information source roadside apparatus 3).

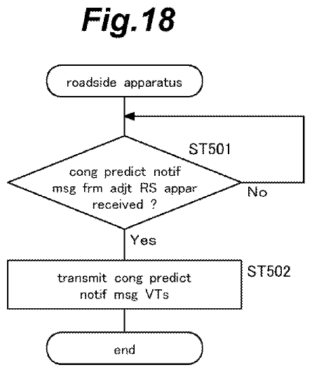

Next, a congestion prediction transfer operation performed by the roadside apparatus 3 according to the second embodiment will be described. FIG. 18 is a flow chart showing an operation procedure of a congestion prediction transfer operation performed by the roadside apparatus 3.

When receiving a congestion prediction notification message from a roadside apparatus 3 at an adjacent intersection at the roadside-to-roadside communication device 33 (Yes in ST501), the roadside apparatus 3 transmits the same congestion prediction notification message as the received one, from the ITS communication device 31 to in-vehicle terminals 2 (ST502). The congestion prediction notification message includes congestion prediction information indicating that there is predicted congestion in the ITS communication and the terminal ID of the information source roadside apparatus 3.

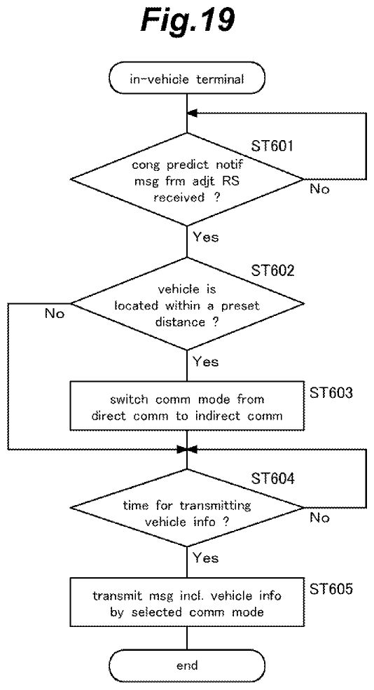

Next, a communication mode selection operation performed by an in-vehicle terminal 2 according to the second embodiment will be described. FIG. 19 is a flow chart showing an operation procedure of a communication mode selection operation performed by an in-vehicle terminal 2.

When receiving the congestion prediction notification message from the roadside apparatus 3 at the ITS communication device 21 (Yes in ST601), an in-vehicle terminal 2 acquires, based on the terminal ID of the information source roadside apparatus 3 included in the message, the position data of an area around the information source roadside apparatus 3; that is an area where congestion is predicted to occur (predicted congestion occurring area). The in-vehicle terminal 2 determines whether or not the vehicle carrying the in-vehicle terminal 2 is within a predetermined distance from the predicted congestion occurring area based on the acquired position data of the predicted congestion occurring area (ST602).

When determining that the vehicle is within a predetermined distance from the predicted congestion occurring area (Yes in ST602), the in-vehicle terminal 2 performs a congestion avoidance operation by switching the communication mode from direct communication mode to indirect communication mode (ST603).

When determining that the vehicle is not within the predetermined distance from the predicted congestion occurring area (No in ST602), the communication mode remains the direct communication mode.

Next, when it is a time for transmitting vehicle information (Yes in ST604), the in-vehicle terminal 2 transmits a message including the vehicle information by using the selected communication mode (ST605). That is, when the direct communication mode is selected, the in-vehicle terminal 2 transmits a message from the ITS communication device 21 to PDH terminals 1, and when the indirect communication mode is selected, the in-vehicle terminal 2 transmits a message from the wireless LAN communication device 22 to PDH terminals 1 via a roadside apparatus(es) 3.

Specific embodiments of the present invention are described herein for illustrative purposes. However, the present invention is not limited to those specific embodiments, and various changes, substitutions, additions, and omissions may be made for features of the embodiments without departing from the scope of the invention. In addition, elements and features of the different embodiments may be combined with each other to yield an embodiment which is within the scope of the present invention.

### INDUSTRIAL APPLICABILITY

A roadside apparatus and a communication congestion control method according to the present disclosure can effectively avoid congestion in ITS communications at a street intersection to thereby properly assist the driving of autonomous vehicles, are useful as a roadside apparatus installed on a road for communicating with terminal devices carried by pedestrians and/or vehicles on the road, and a communication congestion control method for avoiding congestion in terminal-to-terminal communications performed between terminal devices.

### GLOSSARY

1 pedestrian terminal (pedestrian device, terminal device)

2 in-vehicle terminal (in-vehicle device, terminal device)

3 roadside apparatus

11 ITS communication device

12 wireless LAN communication device

13 positioning device

14 memory

15 processor

21 ITS communication device

22 wireless LAN communication device

23 positioning device

24 memory

25 processor

31 ITS communication device (first communication device)

32 wireless LAN communication device

33 roadside-to-roadside communication device (second communication device)

34 camera

35 radar

36 memory

37 processor

51 drone

1. A roadside apparatus comprising:
a first communication device configured to communicate with terminal devices carried by mobile bodies on a road by a communication method common to that used in the terminal-to-terminal communications;
a second communication device configured to communicate with a second roadside apparatus; and
a processor configured to perform controls so as to avoid congestion in the terminal-to-terminal communications,
wherein, when the second communication device receives terminal status information from the second roadside apparatus, the terminal status information indicating a status of a terminal device located near the second roadside apparatus, the processor determines whether or not there s predicted congestion in the terminal-to-terminal communications at a predetermined future time based on the terminal status information, and where determining that there is predicted congestion in the terminal-to-terminal communications at the predetermine future time, the processor transmits an instruction for a congestion avoidance operation to restrict the terminal-to-terminal communications from the first communication device to the terminal devices.

2. The roadside apparatus according to claim 1, wherein the processor is configured to:
receive terminal movement information on a movement direction of the terminal device located near the second roadside apparatus as the terminal status information;
acquire a predicted terminal number, the predicted terminal number being the number of one or more terminal devices present in a communication area of the first communication device at a predetermined future time, based on the terminal movement information; and
when the predicted terminal number is equal to or greater than a predetermined threshold value, determine that there is predicted congestion in the terminal-to-terminal communications.

3. The roadside apparatus according to claim 2, wherein the processor is configured to:
acquire moving directions of the terminal devices located in the communication area;
based on the moving directions of the terminal devices, acquire an entering terminal device number, the entering terminal device number being the number of one or more terminal devices which are predicted to enter a communication area of the second roadside apparatus located adjacent to the roadside apparatus by the predetermined future time; and
transmit the entering terminal device number as terminal movement information to the second roadside apparatus located adjacent to the roadside apparatus.

4. The roadside apparatus according to claim 2, wherein the processor is configured to:
acquire an entering terminal device number as the terminal status information from the second roadside apparatus located adjacent to the roadside apparatus, the entering terminal device number being the number of one or more terminal devices which are predicted to enter the communication area by the predetermined future time; and
add the acquired entering terminal device number to a current terminal number, the current terminal number being the number of one or more terminal devices which are currently present in the communication area, to hereby provide the predicted terminal number.

5. The roadside apparatus according to claim 2, wherein the processor is configured to:
acquire moving directions of the terminal devices located in the communication area;
based on the moving directions of the terminal devices, acquire a leaving terminal number, the leaving terminal number being the number of one or more terminal devices which are predicted to leave the communication area by the predetermined future time; and
subtract the acquired leaving terminal number from a current terminal number, the current terminal number being the number of one or more terminal devices which are currently present in the communication area, to thereby provide the predicted terminal number.

6. A communication congestion control method for avoiding congestion in terminal-to-terminal communications performed by terminal devices carried by mobile bodies on a road, the method comprising:
an information source roadside apparatus acquiring terminal status information indicating a status of a terminal device located near the information source roadside apparatus;
the information source roadside apparatus transmitting the acquired terminal status information to an information destination roadside apparatus;
upon receiving the terminal status information from the information source roadside apparatus, the information destination roadside apparatus determining whether or not there is predicted congestion in the terminal-to-terminal communications at a predetermined future time based on the terminal status information;
when determining that there is predicted congestion in the terminal-to-terminal communications at the predetermine future time, the information destination roadside apparatus transmitting an instruction for a congestion avoidance operation to restrict the terminal-to-terminal communications, to the terminal devices; and
upon receiving the instruction for the congestion avoidance operation from the information destination roadside apparatus, the terminals performing the congestion avoidance operation.

7. The communication congestion control method according to claim 6, wherein the terminal device performs the congestion avoidance operation by switching a communication mode from a direct communication mode using the terminal-to-terminal communications, to an indirect communication mode using communications via a roadside apparatus or a base station for cellular communications.

8. The communication congestion control method according to claim 6, wherein the terminal device performs the congestion avoidance operation by making intervals at which the terminal device transmits messages via the terminal-to-terminal communications, longer than a standard message transmission interval.

9. The communication congestion control method according to claim 6, wherein the terminal device determines whether or not to perform the congestion avoidance operation based on a status and an attribute of the mobile body carrying the terminal device.

10. A communication congestion control method for avoiding congestion in terminal-to-terminal communications performed by terminal devices carried by mobile bodies on a road, the method comprising:
an information source roadside apparatus determining whether or not there is predicted congestion in the terminal-to-terminal communications at a predetermined future time,
when determining that there is predicted congestion in the terminal-to-terminal communications at the predetermine future time, the information source roadside apparatus transmitting congestion prediction information to an information destination roadside apparatus;
upon receiving the congestion prediction information from the information source roadside apparatus, the information destination roadside apparatus transmitting the congestion prediction information to one or more terminal devices located near the information destination roadside apparatus;
when receiving the congestion prediction information from the information destination roadside apparatus, a terminal device mounted in a vehicle as a mobile body performing a congestion avoidance operation by switching a communication mode from a direct communication mode using the terminal-to-terminal communications, to an indirect communication mode using communications via a roadside apparatus or a base station for cellular communications.
